(19) United States
(12) Patent Application Publication
(10) Pub. No.: US 2025/0036468 A1
(43) Pub. Date: Jan. 30, 2025

(54) DYNAMIC TUNING OF PRE-INITIALIZATION ENVIRONMENT PROVISIONING AND MANAGEMENT

(71) Applicant: International Business Machines Corporation, Armonk, NY (US)

(72) Inventors: Dong Hui Liu, Beijing (CN); Jing Lu, Beijing (CN); Peng Hui Jiang, Beijing (CN); NAIJIE LI, Beijing (CN); Xiao Yan Tang, Beijing (CN); Jia Yu, Beijing (CN)

(73) Assignee: International Business Machines Corporation, Armonk, NY (US)

(21) Appl. No.: 18/225,420

(22) Filed: Jul. 24, 2023

(51) Int. Cl. G06F 9/50; G06N 20/00

(52) U.S. Cl. CPC G06F 9/5027; G06N 20/00

(57) ABSTRACT

The illustrative embodiments provide for dynamic tuning of pre-initialization environment provisioning and management. An embodiment includes accepting a request from a group of applications to generate a performance-based index table for a workload based on a feature of the applications and generating the performance-based index table. The embodiment includes building a label feature by analyzing a static program feature of the applications and the performance-based index table. The embodiment includes constructing, using clustering algorithms, a model for provisioning a pre-initialization environment using the label features. The embodiment includes loading the applications into a pre-initialization environment. The embodiment includes introducing a selection policy for a switch in the pre-initialization environment in multiple applications to balance usage of a resource. The embodiment includes updating input to the model in response to monitoring a traffic of requests and collecting real time runtime data of the workload.

### BACKGROUND

The present invention relates generally to pre-initialization environment provisioning and management. More particularly, the present invention relates to a method, system, and computer program for dynamically tuning a pre-initialization environment to improve performance and reduce costs of large-scale data management systems such used in as a data center.

A pre-initialization environment can utilize communication networks to run applications and exchange data. Companies and organizations operate computer networks that interconnect multiple pre-initialization environments to support operations or to provide services to third parties. A pre-initialization environment may be located in a single geographic environment or in multiple, distinct geographic locations. The multiple geographic locations may be interconnected through private or public communication networks. Pre-initialization environment managers or pre-initialization environment processing centers may be referred to as data centers and may include multiple interconnected pre-initialization environments to provide computing resources to users of the data centers. The data centers may be private data centers operated on behalf of an organization or public data centers operated on behalf of, or for the benefit of, the general public.

To facilitate increased utilization of data center resources, technologies allow a single point to host one or more instances of a pre-initialization environment that appear and operate as an independent one to user of a data center. With this, the single point can create, maintain, delete, or otherwise manage pre-initialization environments in a dynamic manner. In turn, users can request pre-initialization environments from a data center, including a single pre-initialization environment or a configuration of networked pre-initialization environments, and be provided with varying numbers of pre-initialization environment resources.

In some scenarios, pre-initialization environment instances may be manually configured according to a number of virtual machine instance types to provide specific functionality. For example, various pre-initialization environments may be associated with different combinations of operating systems (OS) or operating system (OS) configurations, virtualized hardware resources and software applications to enable a pre-initialization environment to provide different desired functionalities, or to provide similar functionalities more efficiently. These pre-initialization environment instance type configurations are often contained within an image, which includes static data containing the software such as, the operating system (OS) and applications together with their configuration and data files, that the pre-initialization environment will run once started. The image is typically stored on the disk used to create or initialize the instance. Thus, a pre-initialization environment may process the image in order to implement the desired software configuration.

### SUMMARY

The illustrative embodiments provide for dynamic tuning of pre-initialization environment provisioning and management. An embodiment includes accepting a request from a group of applications to generate a performance-based index table for a workload based on a feature of the applications. The embodiment also includes generating the performance-based index table for the workload where the performance-based index is based on a memory efficiency. The embodiment also includes building a label feature by analyzing a static program feature of the applications in the group of applications and the performance-based index table. The embodiment also includes constructing, using clustering algorithms, a model for provisioning a pre-initialization environment using the label feature. The embodiment also includes loading, using the label, the applications in the group of applications into the pre-initialization environment. The embodiment also includes introducing a selection policy for a switch in the pre-initialization environment in an application to balance usage of at least one resource.

Balancing the usage of the applications increases efficiency of the programs by decreasing or increasing space as needed. Balancing the usage may also help reduce costs since less resources may be required at different times. Scaling of the system to meet the needs of the application in real time increases the efficiency of the system overall. Scaling in real time also decreases any down time that may be associated with having to manually add, delete, or increase the size of pre-initialization environments. The embodiment also includes updating input to the model in response to monitoring a traffic of requests and collecting runtime data of the workload. Updating the clustering model includes adjusting the model for provisioning a pre-initialization environment. Provisioning the pre-initialization environment allows the system to increase or decrease usage of resources as required which helps to decrease costs and increase speeds. Other embodiments of this aspect include corresponding computer systems, apparatus, and computer programs recorded on one or more computer storage devices, each configured to perform the actions of the embodiment.

A resource of the pre-initialization environments may include space, memory, and speed of the system. By balancing usage of the resources efficiency of a data system can be increased. Time and money can also be saved by sorting the applications based on similar usage of the system.

The embodiment also includes providing a manager to support scaling of the pre-initialization environment based on collection of runtime data of the workload. The manager creates, adds, or deletes pre-initialization environments based on changes in the clustering performance index. If the pre-initialization environment manager identifies that the pre-initialization environment performance index is low and not suitable for the current applications running on it the pre-initialization environment automatic tuning will be started for this environment.

In the embodiment, the performance-based index may also be based on a priority weight of the workload. In other embodiments, the performance-based index may be also be based on an actual response time to goal.

Scaling in the embodiment may include inserting, updating, and deleting the pre-initialization environment. Scaling in response to real time usage increases efficiency of the system. Realtime scaling also ensures that pre-initialization environments are available and appropriately sized for the quantity of applications in use in a system.

Adjusting the model for provisioning the pre-initialization environment includes increasing a size of the pre-initialization environment. By increasing the size of the pre-initialization environment more applications are able to be added to the pre-initialization environment which increases efficiency of the system because more similar applications are run together.

Adjusting the model for provisioning the pre-initialization environment includes decreasing a size of the pre-initialization environment. By decreasing the size of the pre-initialization environment resources are preserved for use in other parts of the system and the system is more efficient.

Adjusting the model for provisioning the pre-initialization environment includes deleting the pre-initialization environment. Deleting a pre-initialization environment that is no longer in use frees up resources that may be used in other parts of the system.

Adjusting the model for provisioning the pre-initialization environment includes creating at least one of the pre-initialization environment. Creating a pre-initialization environment when a new clustering node is generated increases the efficiency of the system.

One static feature of the application may include an intensity of input and output operations of the application, a memory efficiency of the application, and an actual response time of the application. Grouping applications together by static features in a pre-initialization environment may increase efficiency of the system because the application has similar runtimes or sizes when loaded together.

The embodiment also includes predicting, using an artificial intelligence (AI) algorithm, a usage of the pre-initialization environment by applying a program feature and across the program features. Predicting usage of the pre-initialization environment with an AI algorithm may allow a system function to independently from a user. Predicting usage also allows the system to change parameters of the node and pre-initialization environments dynamically in response to real time run data. Dynamic changes to the pre-initialization environments allow the system to adapt to rapidly changing needs.

An embodiment includes a computer program product including one or more computer readable storage media, and program instructions collectively stored on the one or more computer readable storage media, the program instructions executable by a processor to cause the processor to perform operations. The embodiment includes accepting a request from a group of applications to generate a performance-based index table for a workload based at least in part on a feature of the applications. The embodiment also includes generating the performance-based index table for the workload. The embodiment also includes building an a label feature by analyzing a one static program feature of the applications in the group of applications and the performance-based index table. The embodiment also includes constructing, using clustering algorithms, a model for provisioning a pre-initialization environment using the label features.

The embodiment also includes loading, using the label features, the applications in the group of applications into the pre-initialization environment. The embodiment also introduces a selection policy for a switch in each of the pre-initialization environments in multiple applications to balance usage of at least one resource. The embodiment also includes updating input to the model in response to monitoring a traffic of requests and collecting runtime data of the workload. Updating the model includes adjusting the model for provisioning the pre-initialization environments.

Stored program instructions are stored in a computer readable storage device in a data processing system and the stored program instructions are transferred over a network from a remote data processing system.

At least one resource of the pre-initialization environments may include space, memory, and speed. By grouping applications into pre-initialization environment having similar resources the applications can run more efficiently.

The embodiment also includes providing a pre-initialization environment manager to support scaling of the pre-initialization environment based on collection of runtime data of the workload. Scaling supported by an internal pre-initialization environment manager allows the system to dynamically scale in response to real time run data making the system more efficient.

Scaling in the embodiment may include inserting, updating, and deleting the pre-initialization environment. Scaling in response to real time usage increases efficiency of the system. Realtime scaling also ensures that pre-initialization environments are available and appropriately sized for the quantity of applications in use in a system.

The embodiment also includes predicting, using an artificial intelligence algorithm, a usage of the pre-initialization environment by applying a program feature and resource across the program features. By predicting usage by the applications, the quantity and sizes of the pre-initialization environments can be prepared in advance of a need to ensure adequate resources are available when needed by the applications.

An embodiment includes a computer system. The computer system includes a processor, one or more computer readable storage media, and program instructions collectively stored on the one or more computer readable storage media. The program instructions are executable by the processor to cause the processor to perform operations. The operations may include accepting a request from a group of applications to generate a performance-based index table for a workload based at least in part on a feature of the applications. The operations may also include generating the performance-based index table for the workload. The operations may also include building a label feature by analyzing at least one static program feature of the applications in the group of applications and the performance-based index table. The label feature may be an n-dimensional label. The operations may also include constructing, using clustering algorithms, a model for provisioning a pre-initialization environment using the label features. The operations may also include loading, using the label features, the applications in the group of applications into the pre-initialization environment. The operations may also include introducing a selection policy for a switch in the pre-initialization environment in multiple applications to balance usage of a resource. The operations may also include updating input to the model in response to monitoring a traffic of requests and collecting runtime data of the workload where updating the model includes adjusting the model for provisioning the environments.

Scaling in the embodiment may include inserting, updating, and deleting the at least one pre-initialization environment. Scaling in response to real time usage increases efficiency of the system. Realtime scaling also ensures that pre-initialization environments are available and appropriately sized for the quantity of applications in use in a system.

The embodiment also includes a computing environment. The computing environment includes a shared pool of configurable computing resources and at least one data processing system included in the configurable computing resources where the at least one data processing system includes a processor unit and a data storage unit. The computing environment also includes a service delivery model to deliver on-demand access to the shared pool of resources and a metering capability to measure a service delivered via the service delivery model. The computing environment also includes program instructions collectively stored on one or more computer readable storage media. The program instructions are executable by the processor unit to cause the processor unit to perform operations.

The operations include accepting a request from a group of applications to generate a performance-based index table for a workload based at least in part on a feature of the applications. The operations also include generating the performance-based index table for the workload where the performance-based index is based on a memory efficiency. The operations also include building a label feature by analyzing a static program feature of the application in the group of applications and the performance-based index table. The operations also include constructing a model for provisioning a pre-initialization environment using a label feature using a clustering algorithm. The operations also include loading, using the label feature, the applications in the group of applications into the pre-initialization environment using the label feature. The operations also include introducing a selection policy for a switch in a pre-initialization environment in an application to balance usage of at least one resource. The operations also include updating input to the model in response to monitoring a traffic of requests and collecting runtime data of the workload, wherein updating the model comprises adjusting the model for provisioning the pre-initialization environment.

Scaling includes inserting, updating, and deleting the at least one pre-initialization environment. Scaling in response to real time usage increases efficiency of the system. Realtime scaling also ensures that pre-initialization environments are available and appropriately sized for the quantity of applications in use in a system.

The operations also include predicting a usage of the pre-initialization environment by applying a program feature and a resource across the program features using an artificial intelligence algorithm. By predicting usage by the applications, the quantity and sizes of the pre-initialization environments can be prepared in advance of a need to ensure adequate resources are available when needed by the applications.

The embodiment includes a software delivery architecture. The software architecture includes a shared pool of configurable computing resources and at least one data processing system included in the shared pool of configurable computing resources. The at least one data processing system includes a processor unit and a data storage unit. The software architecture includes at least one data networking component configured to enable data communication with the at least one data processing system. The software architecture also includes an application control mechanism to execute a software application that is deployed to execute using the at least one data processing system. The software architectures also includes program instructions of the software application, wherein the program instructions are executable by the processor unit to cause the processor unit to perform operations.

The operations include accepting a request from a group of applications to generate a performance-based index table for a workload based at least in part on a feature of the applications. The operations also include generating the performance-based index table for the workload where the performance-based index is based on a memory efficiency. The operations also include building a label feature by analyzing a static program feature of the application in the group of applications and the performance-based index table. The operations also include constructing a model for provisioning a pre-initialization environment using a label feature using a clustering algorithm. The operations also include loading, using the label feature, the applications in the group of applications into the pre-initialization environment using the label feature. The operations also include introducing a selection policy for a switch in a pre-initialization environment in an application to balance usage of at least one resource. The operations also include updating input to the model in response to monitoring a traffic of requests and collecting runtime data of the workload, wherein updating the model comprises adjusting the model for provisioning the pre-initialization environment.

The software service delivery architecture also includes predicting a usage of the pre-initialization environment by applying a program feature and a resource across the program features using an artificial intelligence algorithm. By predicting usage by the applications, the quantity and sizes of the pre-initialization environments can be prepared in advance of a need to ensure adequate resources are available when needed by the applications.

The embodiment also includes predicting, using an artificial intelligence algorithm, a usage of the environment by applying a program feature and a resource across the program features. By predicting usage by the applications, the quantity and sizes of the pre-initialization environment can be prepared in advance of a need to ensure adequate resources are available when needed by the applications.

The embodiment also includes providing a pre-initialization environment manager to support scaling of the pre-initialization environment based on collection of runtime data of the workload. Scaling supported by an internal pre-initialization environment manager allows the system to dynamically scale in response to real time run data making the system more efficient.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of a computer architecture of a dynamic pre-initialization environment in accordance with an illustrative embodiment;

FIG. 3 depicts a block diagram of an example method of dynamically tuning a pre-initialization environment in accordance with an illustrative embodiment;

FIG. 4 depicts a block diagram of an example method of extracting application features in accordance with an illustrative embodiment;

FIG. 5 depicts a block diagram of an example method of predicting application requirements and routes in accordance with an illustrative embodiment;

FIG. 6 depicts a block diagram of an example method dynamically adjusting a pre-initialization environment in accordance with an illustrative embodiment;

FIG. 7 depicts a block diagram of another example method dynamically adjusting a pre-initialization environment in accordance with an illustrative embodiment;

FIG. 8 depicts a block diagram of another example method dynamically adjusting a pre-initialization environment in accordance with an illustrative embodiment;

FIG. 9 depicts a block diagram of an example monitoring process in accordance with an illustrative embodiment; and

FIG. 10 depicts a block diagram of an example process dynamically tuning storage of a pre-initialization environment in accordance with an illustrative embodiment;

FIG. 11 depicts a block diagram of an example process for training storage tuning of a pre-initialization environment in accordance with an illustrative embodiment;

FIG. 12 depicts a block diagram of an example process for storage tuning predicting and routing in a pre-initialization environment in accordance with an illustrative embodiment;

FIG. 13 depicts a block diagram as an example process dynamically adjusting of a pre-initialization environment in accordance with an illustrative embodiment; and

FIG. 14 depicts a block diagram as an example process dynamically adjusting of a pre-initialization environment in accordance with an illustrative embodiment.

### DETAILED DESCRIPTION

According to an aspect of the invention, there is provided an embodiment that includes accepting a request from a group of applications to generate a performance-based index table for a workload based on a feature of the applications. The embodiment also includes generating the performance-based index table for the workload where the performance-based index is based on a memory efficiency. The embodiment also includes building a label feature by analyzing a static program feature of the applications in the group of applications and the performance-based index table. The embodiment also includes constructing, using clustering algorithms, a model for provisioning a pre-initialization environment using the label feature. The embodiment also includes loading, using the label, the applications in the group of applications into the pre-initialization environment. The embodiment also includes introducing a selection policy for a switch in the pre-initialization environment in an application to balance usage of at least one resource.

Balancing the usage of the applications increases efficiency of the programs by decreasing or increasing space as needed. Balancing the usage may also help reduce costs since less resources may be required at different times. Scaling of the system to meet the needs of the application in real time increases the efficiency of the system overall. Scaling in real time also decreases any down time that may be associated with having to manually add, delete, or increase the size of pre-initialization environments. The embodiment also includes updating input to the model in response to monitoring a traffic of requests and collecting runtime data of the workload. Updating the clustering model includes adjusting the model for provisioning a pre-initialization environment. Provisioning the pre-initialization environment allows the system to increase or decrease usage of resources as required which helps to decrease costs and increase speeds. Other embodiments of this aspect include corresponding computer systems, apparatus, and computer programs recorded on one or more computer storage devices, each configured to perform the actions of the embodiment.

In embodiments, a resource of the pre-initialization environments may include space, memory, and speed of the system. By balancing usage of the resources efficiency of a data system can be increased. Time and money can also be saved by sorting the applications based on similar usage of the system.

In embodiments, a manager is provided to support scaling of the pre-initialization environment based on collection of runtime data of the workload. The manager creates, adds, or deletes pre-initialization environments based on changes in the clustering performance index. If the pre-initialization environment manager identifies that the pre-initialization environment performance index is low and not suitable for the current applications running on it the pre-initialization environment automatic tuning will be started for this environment.

In embodiments, the performance-based index may also be based on a priority weight of the workload. In other embodiments, the performance-based index may be also be based on an actual response time to goal.

In embodiments, scaling in the embodiment may include inserting, updating, and deleting the pre-initialization environment. Scaling in response to real time usage increases efficiency of the system. Realtime scaling also ensures that pre-initialization environments are available and appropriately sized for the quantity of applications in use in a system.

In embodiments, adjusting the model for provisioning the pre-initialization environment includes increasing a size of the pre-initialization environment. By increasing the size of the pre-initialization environment more applications are able to be added to the pre-initialization environment which increases efficiency of the system because more similar applications are run together.

In embodiments, adjusting the model for provisioning the pre-initialization environment includes decreasing a size of the pre-initialization environment. By decreasing the size of the pre-initialization environment resources are preserved for use in other parts of the system and the system is more efficient.

In embodiments, adjusting the model for provisioning the pre-initialization environment includes deleting the pre-initialization environment. Deleting a pre-initialization environment that is no longer in use frees up resources that may be used in other parts of the system.

In embodiments, adjusting the model for provisioning the pre-initialization environment includes creating at least one of the pre-initialization environment. Creating a pre-initialization environment when a new clustering node is generated increases the efficiency of the system.

In embodiments, one static feature of the application may include an intensity of input and output operations of the application, a memory efficiency of the application, and an actual response time of the application. Grouping applications together by static features in a pre-initialization environment may increase efficiency of the system because the application has similar runtimes or sizes when loaded together.

In embodiments, a usage of the pre-initialization environment is predicted by applying a program feature and across the program features using an artificial intelligence (AI) algorithm. Predicting usage of the pre-initialization environment with an AI algorithm may allow a system function to independently from a user. Predicting usage also allows the system to change parameters of the node and pre-initialization environments dynamically in response to real time run data. Dynamic changes to the pre-initialization environments allow the system to adapt to rapidly changing needs.

According to an aspect of the invention, a computer program product includes having one or more computer readable storage media and program instructions collectively stored on the one or more computer readable storage media. The program instructions are executable by a processor to cause the processor to perform operations. The embodiment includes accepting a request from a group of applications to generate a performance-based index table for a workload based at least in part on a feature of the applications. The embodiment also includes generating the performance-based index table for the workload. The embodiment also includes building a label feature by analyzing a one static program feature of the applications in the group of applications and the performance-based index table. The embodiment also includes constructing a model for provisioning a pre-initialization environment using the label features using clustering algorithms.

In an embodiment, the applications in the group of applications into the pre-initialization environment are loaded using the label features. The embodiment also introduces a selection policy for a switch in each of the pre-initialization environments in multiple applications to balance usage of at least one resource. The embodiment also includes updating input to the model in response to monitoring a traffic of requests and collecting runtime data of the workload. Updating the model includes adjusting the model for provisioning the pre-initialization environments.

In embodiments, stored program instructions are stored in a computer readable storage device in a data processing system. The stored program instructions are transferred over a network from a remote data processing system.

In embodiments, at least one resource of the pre-initialization environments may include space, memory, and speed. By grouping applications into pre-initialization environment having similar resources the applications can run more efficiently.

In embodiments, a pre-initialization environment manager provides support for scaling of the pre-initialization environment based on collection of runtime data of the workload. Scaling supported by an internal pre-initialization environment manager allows the system to dynamically scale in response to real time run data making the system more efficient.

In embodiments, scaling in the embodiment may include inserting, updating, and deleting the pre-initialization environment. Scaling in response to real time usage increases efficiency of the system. Realtime scaling also ensures that pre-initialization environments are available and appropriately sized for the quantity of applications in use in a system.

In embodiments predicting, a usage of the pre-initialization environment is predicted, using an artificial intelligence algorithm by applying a program feature and resource across the program features. By predicting usage by the applications, the quantity and sizes of the pre-initialization environments can be prepared in advance of a need to ensure adequate resources are available when needed by the applications.

According to an aspect of the invention, a computer system is included. The computer system includes a processor, one or more computer readable storage media, and program instructions collectively stored on the one or more computer readable storage media. The program instructions are executable by the processor to cause the processor to perform operations. The operations may include accepting a request from a group of applications to generate a performance-based index table for a workload based at least in part on a feature of the applications. The operations may also include generating the performance-based index table for the workload. The operations may also include building a label feature by analyzing at least one static program feature of the applications in the group of applications and the performance-based index table. The label feature may be an n-dimensional label. The operations may also include constructing, using clustering algorithms, a model for provisioning a pre-initialization environment using the label features. The operations may also include loading, using the label features, the applications in the group of applications into the pre-initialization environment. The operations may also include introducing a selection policy for a switch in the pre-initialization environment in multiple applications to balance usage of a resource. The operations may also include updating input to the model in response to monitoring a traffic of requests and collecting runtime data of the workload where updating the model includes adjusting the model for provisioning the environments.

In embodiments predicting, scaling in the embodiment may include inserting, updating, and deleting the at least one pre-initialization environment. Scaling in response to real time usage increases efficiency of the system. Realtime scaling also ensures that pre-initialization environments are available and appropriately sized for the quantity of applications in use in a system.

According to an aspect of the invention, the embodiment also includes a computing environment. The computing environment includes a shared pool of configurable computing resources and at least one data processing system included in the configurable computing resources where the at least one data processing system includes a processor unit and a data storage unit. The computing environment also includes a service delivery model to deliver on-demand access to the shared pool of resources and a metering capability to measure a service delivered via the service delivery model. The computing environment also includes program instructions collectively stored on one or more computer readable storage media. The program instructions are executable by the processor unit to cause the processor unit to perform operations.

The operations include accepting a request from a group of applications to generate a performance-based index table for a workload based at least in part on a feature of the applications. The operations also include generating the performance-based index table for the workload where the performance-based index is based on a memory efficiency. The operations also include building a label feature by analyzing a static program feature of the application in the group of applications and the performance-based index table. The operations also include constructing a model for provisioning a pre-initialization environment using a label feature using a clustering algorithm. The operations also include loading, using the label feature, the applications in the group of applications into the pre-initialization environment using the label feature. The operations also include introducing a selection policy for a switch in a pre-initialization environment in an application to balance usage of at least one resource. The operations also include updating input to the model in response to monitoring a traffic of requests and collecting runtime data of the workload, wherein updating the model comprises adjusting the model for provisioning the pre-initialization environment.

Scaling includes inserting, updating, and deleting the at least one pre-initialization environment. Scaling in response to real time usage increases efficiency of the system. Realtime scaling also ensures that pre-initialization environments are available and appropriately sized for the quantity of applications in use in a system.

The operations also include predicting a usage of the pre-initialization environment by applying a program feature and a resource across the program features using an artificial intelligence algorithm. By predicting usage by the applications, the quantity and sizes of the pre-initialization environments can be prepared in advance of a need to ensure adequate resources are available when needed by the applications.

According to an aspect of the invention, a software delivery architecture is included. The software architecture includes a shared pool of configurable computing resources and at least one data processing system included in the shared pool of configurable computing resources. At least one data processing system includes a processor unit and a data storage unit. The software architecture includes at least one data networking component configured to enable data communication with the at least one data processing system. The software architecture also includes an application control mechanism to execute a software application that is deployed to execute using the at least one data processing system. The software architecture also includes program instructions of the software application, wherein the program instructions are executable by the processor unit to cause the processor unit to perform operations.

The operations include accepting a request from a group of applications to generate a performance-based index table for a workload based at least in part on a feature of the applications. The operations also include generating the performance-based index table for the workload where the performance-based index is based on a memory efficiency. The operations also include building a label feature by analyzing a static program feature of the application in the group of applications and the performance-based index table. The operations also include constructing a model for provisioning a pre-initialization environment using a label feature using a clustering algorithm. The operations also include loading, using the label feature, the applications in the group of applications into the pre-initialization environment using the label feature. The operations also include introducing a selection policy for a switch in a pre-initialization environment in an application to balance usage of at least one resource. The operations also include updating input to the model in response to monitoring a traffic of requests and collecting runtime data of the workload, wherein updating the model comprises adjusting the model for provisioning the pre-initialization environment.

The software service delivery architecture also includes predicting a usage of the pre-initialization environment by applying a program feature and a resource across the program features using an artificial intelligence algorithm. By predicting usage by the applications, the quantity and sizes of the pre-initialization environments can be prepared in advance of a need to ensure adequate resources are available when needed by the applications.

A pre-initialization environment facilitates creating and initializing a common runtime environment for applications, execute application with the pre-initialized environment, and terminate the pre-initialized environment. A pre-initialized environment is commonly used to enhance performance for repeated invocations of an application or for a complex application where there are many repetitive requests and where fast response is required.

A pre-initialized environment can be in a single geographic location or located in multiple, distinct geographic locations. The pre-initialized environments can be interconnected through a private or public communication network. For example, a pre-initialization manager or pre-initialization or pre-initialization processing center, herein referred to as a “data center,” may include a number of interconnected pre-initialization environments to provide computing resources to users of the data center. A pre-initialization environment can be used in a cloud environment, data management and data centers.

To facilitate increased utilization of data center resources, technologies may allow a single point to host one or more instances of pre-initialization environments that appear and operate as independent pre-initialization environment to use a data center. With this, the single point can create, maintain, delete, or otherwise manage, pre-initialization environments in a dynamic manner.

In some scenarios, pre-initialization instances may be configured according to a number of machine instance types to provide specific functionality. For example, various pre-initialization environment instances may be associated with different combinations of operating systems or operating configurations, virtualized hardware resources and software applications to enable a pre-initialization environment to provide different desired functionalities. Various pre-initialization environments may also provide similar functionalities more efficiently.

However, there are many challenges that cannot be easily addressed when provisioning and managing pre-initialization environments. These challenges include difficulty in determining resource requirements. It may be challenging to accurately determine resource requirements of a pre-initialization environment especially for complex systems including data centers. If resource allocation is insufficient, the initialization process may fail or take longer than expected. In other situations, if resource allocation is excessive, resources may be wasted, and unnecessary expenses incurred.

Another challenge when provisioning and managing pre-initialization environments is difficulty in scalability. A pre-initialization environment may need to be scalable to accommodate future growth. It can be challenging to predict future resource requirements. If the pre-initialization environment is not designed to be scalable there may be additional costs associated with increasing resources. There may also be downtime when scaling the pre-initialization environment up or down.

In order to resolve the issues above, this disclosure presents a method for enhancing performance and reducing costs by dynamically provisioning and managing the Pre-Init Environment. By autotuning the model in various stages, multiple pre-initialization environments can be generated for different applications. Furthermore, a pre-initialization environment can be added, removed, or scaled automatically, based on input source changes. This approach is highly technically valuable for Pre-Init Environment management, regardless of whether it is deployed in a cloud environment or not. The method includes tuning the instantiated services dynamically.

The illustrative embodiments provide for dynamic tuning of pre-initialization environment provisioning and management. A static feature as referred to herein is a feature of an application that does not change. For example, a static feature may include intensity of input/output operations of the application, a memory efficiency of the application and an actual response time of the application. However, use of this example is not intended to be limiting but is instead used for descriptive purposes only. A label feature as referred to herein includes a feature of an application that may be useful in increasing the performance of the application. The label features may automatically be extracted by the method. In other embodiments, a user may choose the label features. However, use of this example is not intended to be limiting but is instead used for descriptive purposes only. A selection policy as referred to herein includes the process of moving application into a pre-initialization environment based on the clustering label. The clustering label may include a label feature.

Illustrative embodiments for dynamically tuning pre-initialization environment provisions management may improve performance and reduce costs. The embodiments may include accepting a request for a group of applications and generating a performance index table for the workloads. The performance index table may be based on input/output intensity, memory efficiency, and actual response time to the goal. In various implementations, a user may predefine the performance metrics to be featured in the performance index. The embodiment includes building label features automatically by analyzing at least one static program features of the applications in the group of applications and the performance-based index table. The label features may include nodes. Label features may also be used in building n-dimensional label features.

Illustrative embodiments may include constructing a model for provisioning at least one pre-initialization environment using clustering algorithms. The clustering algorithms process the n-dimension label features to provision pre-initialization environments corresponding to the nodes corresponding to the label features. The embodiment may include loading the applications in the group of applications into the at least one pre-initialization environments. In various embodiments multiple pre-initialization environments may be provisioned to accommodate the common label features of the application. Provisioned as referred to herein includes creating a pre-initialization environment. Pre-initialization environments may be provisioned automatically based on usage of the resources in the system. Pre-initialization environments may also be provisioned as new applications are loaded into the system. The embodiment may associate customer requests with available services automatically.

Illustrative embodiments may include introducing a selection policy for pre-initialization switches in multiple applications to balance usage of resources in the system of applications. Resources as referred to herein may include space, memory, and speed of the system. The performance benefits are greatest when the memory consumption is minimal.

Illustrative embodiments include managing pre-initialization environments automatically at the most appropriate moment while considering both memory usage and performance. Embodiments include managing pre-initialization environments automatically, preventing users including, experts and system administrators, from manually tuning based on their experience.

Illustrative embodiments may also include updating input into the clustering model in response to monitoring traffic requests and collecting runtime data of the workload. Updating the clustering model may include adjusting the model for provisioning at least on pre-initialization environments. In various embodiments, traffic requests may come from a user. In other embodiments, traffic requests may come from the applications in the system. In still other embodiments, traffic requests may come from new applications added to the system. The embodiment may also include a manager to support scaling of the pre-initialization environment. In various embodiments, the manager may increase the size of a pre-initialization environment. The manager may also create or delete a pre-initialization environment in response to real time performance data collected by the system. In some embodiments, the manager may change the features of a pre-initialization environment based on performance data gathering as will be explained in a later figure.

By non-limiting example, the manager will increase stack size of a pre-initialization environment if the performance index shows most applications running on a pre-initialization environment are memory intensive. Memory intensive as referred to herein means an amount of memory is being used above an expected threshold of memory usage. The memory usage is above a threshold of memory usage because an initial stack size and heap size is not large enough. The manager will increase the stack size of this pre-initialization environment and then refresh the pre-initialization environment classification table.

Illustrative embodiments may use an artificial intelligence (AI) model to predict usage of the pre-initialization environments by applying at least one program feature and at least one resource across the program features. Multiple AI models may be used to classify the performance index.

Illustrative embodiments include building label features automatically by combining static program features and runtime features of a workload to decide an appropriate pre-initialization environment route. An embodiment may build a performance index table for workloads, and the performance index may be based on priority weight, memory efficiency and actual response time to goal.

Illustrative embodiments may use analytics and machine learning methods based on program features and resource access features to predict the usage of pre-initialization environment and dynamically tune the pre-initialization environment life cycle among multiple applications in an operating system. Illustrative embodiments include introducing selection policy for pre-initial environment switches in multiple applications to balance usage of resource.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures, therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

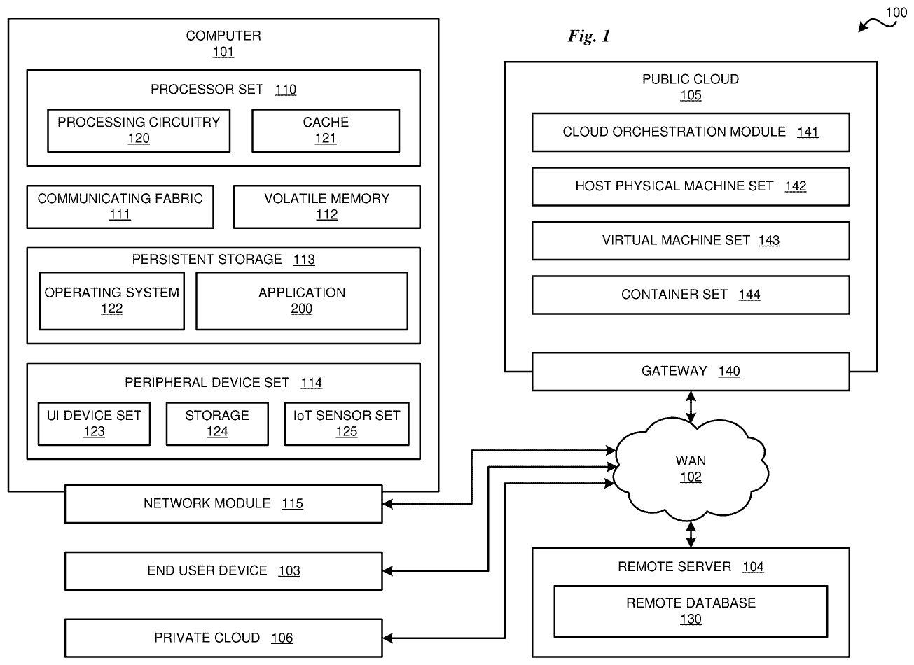

With reference to FIG. 1, this figure depicts a block diagram of a computing environment 100. Computing environment 100 contains an example of an environment for the execution of at least some of the computer code involved in performing the inventive methods, such as an improved pre-initialization module 200 that provides dynamic tuning of pre-initialization environment provisioning and management that modifies usage of the pre-initialization environments based on performance data gathered continuously. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

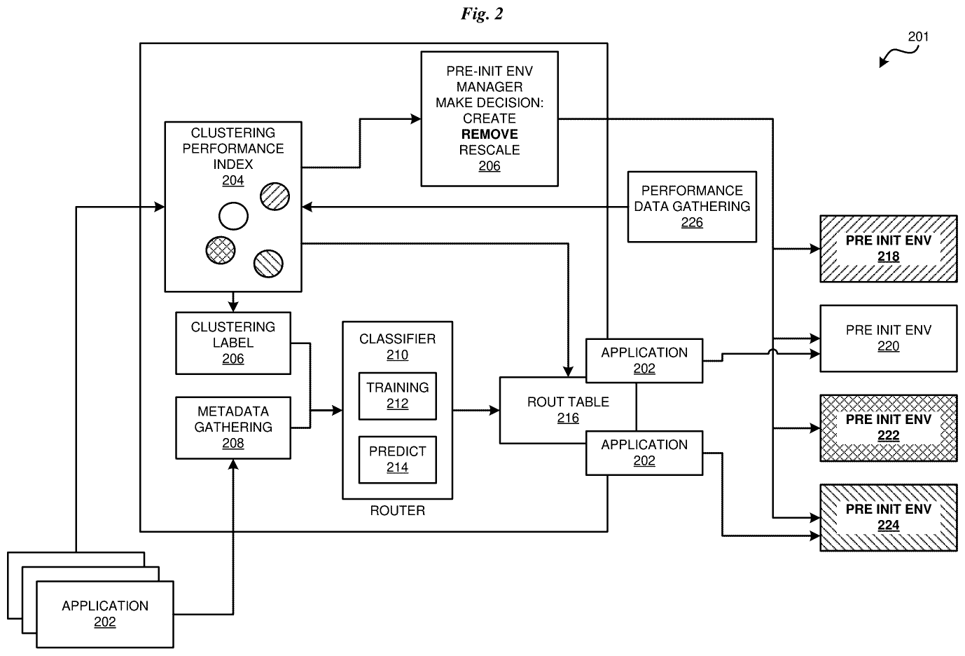

With reference to FIG. 2, this figure depicts a block diagram of the computer architecture of an example dynamic pre-initialization environment system 201 in accordance with an illustrative embodiment. In the illustrated embodiment, the pre-initialization environment system architecture 201 includes the application 200 of FIG. 1.

In the illustrated embodiment, the architecture 201 oversees and manages the pre-initialization environments 218, 220, 222, and 224 of a data system. The architecture includes four parts. The first part includes applications 202, clustering performance index 204, the pre-initialization environment manager 206 collects historical data from application history. The historical data may include performance data from the applications. The clustering algorithm will cluster the performance data into nodes 205. After clustering, the nodes 205 will be used for the performance index 204 that will be managed by the system. The pre-initialization manager will provision four types of pre-initialization environments 218, 220, 222, and 224 to correspond with the nodes 205 as illustrated by the similar patterns in the nodes and the pre-initialization environment blocks. The route tables 216 will be updated to route each application matching a performance index to the corresponding pre-initialization environment.

A second part of the architecture will use the clustering labels 206 to automatically label the training dataset 212 for classification in the classifier 210. The system will train the classification model with historical data from the applications 202.

The third part of the architecture will predict the performance index requirement using the prediction block 214 of the classifier. The prediction block will gather static data from the application. Using the predicted values the system will route applications 202 to the proper pre-initialization environment using the routing table 216.

The fourth part of the architecture will collect real time performance data through the performance data block 226. The performance data block 226 gathers data from the pre-initialization environments 218, 220, 222, and 224 and sends the data to the clustering performance index 204. The system uses the real time performance data to dynamically adjust tuning and management of the pre-initialization environments 218, 220, 222, and 224. The pre-initialization manager 206 will make decisions on whether to create, remove, or rescale the pre-initialization environments. The embodiment will retrain the clustering model 204 to adjust future scalability of business users and user application changes.

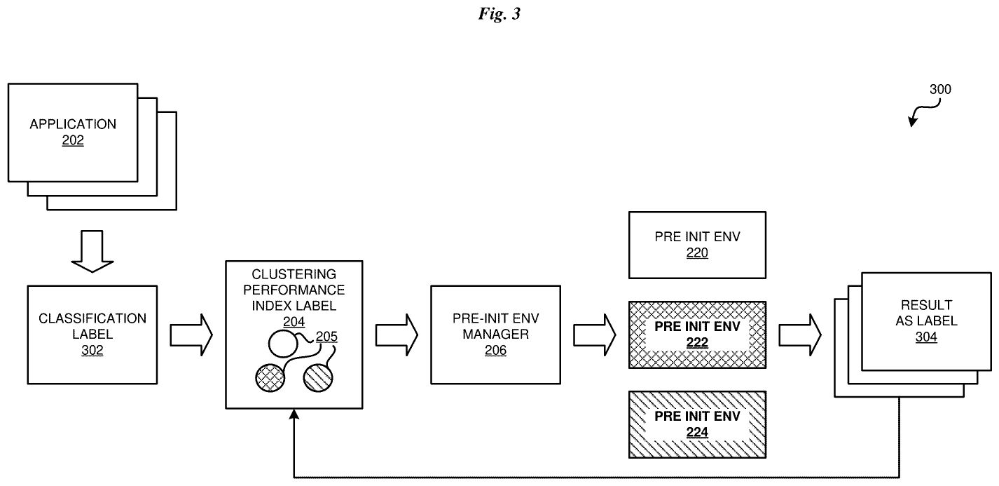

With reference to FIG. 3, this figure depicts a block diagram of an embodiment of the initialization of the dynamic management of the pre-initialization environment system. The embodiment includes accepting a request from a group of applications 202 to generate a performance-based index table for a workload. A performance-based index is generated for the workload using the historical data. The performance-based data may be based on priority weight, a memory efficiency, and an actual response time to goal. The historical data is gathered from the applications 202 by the classification label box 302. The classification labels 302 are clustered in the clustering performance index label box 204. The embodiment includes building label features automatically by analyzing at least one static program feature of the application 202 in the group of applications and the performance-based index table.

The embodiment includes constructing a model for provisioning at least one pre-initialization environment, using clustering algorithms in the clustering performance index label box 204. The embodiment includes loading, using the label features from the clustering algorithm, the applications in the group of applications into the appropriate pre-initialization environments 220, 222, and 224 corresponding to a clustering labeling node. The pre-initialization environment manager 206 loads the applications into the appropriate pre-initialization environments.

After the initialization is set up and run, the system collects results of the applications 202 in the pre-initialization environments 220, 222, and 224. The results 304 will be used as labels of the features of the applications in each of the pre-initialization environments. The result labels will be added to the clustering training data set 212 of FIG. 2. The training data set will then recalibrate using a clustering algorithm the performance index labels according to the result labels 304. After recalibrating, the pre-initialization environment manager 206 will change the pre-initialization environments, as necessary. Changing the pre-initialization environments may include adding a pre-initialization environment, deleting a pre-initialization environment, or rescaling a pre-initialization environment. In some embodiments, performance metrics that are used in the clustering algorithm may be set by a user. The user may set the performance metrics based on needs and interests of the user. In various embodiments, a user may include a business.

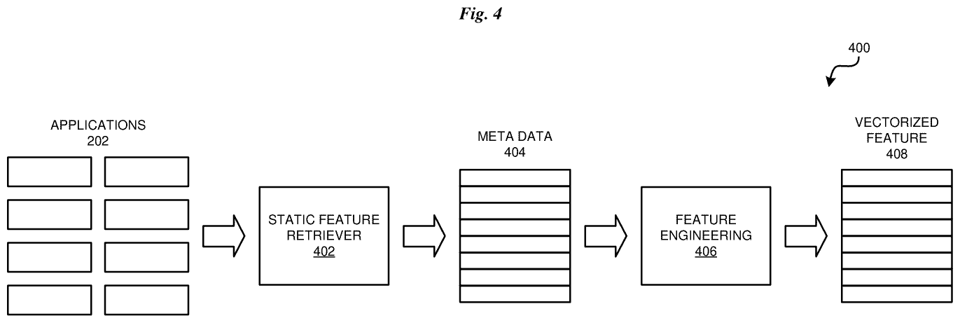

With reference to FIG. 4, this figure depicts a block diagram of an embodiment of extracting application features 400. The embodiment extracts static features 402 from the executable portions of applications 202. As referred to herein executables include the programs used to run the applications. Static features may include an intensity of input/output operations of the application, a memory efficiency of the application and an actual response time of the application. The meta data 404 of the static features is extracted in the meta data block 404. The meta data may include, but is not limited to, the application name, module size, import functions, export functions, symbol table, and operation code n-grams. In feature engineering block 406 the meta data is converted to vectored data 408 in order for the data to be understood by artificial intelligence (AI) algorithms and models. The vectored data features are used in the training block 212 of FIG. 2 to train the AI algorithm to predict program features and resources in the applications.

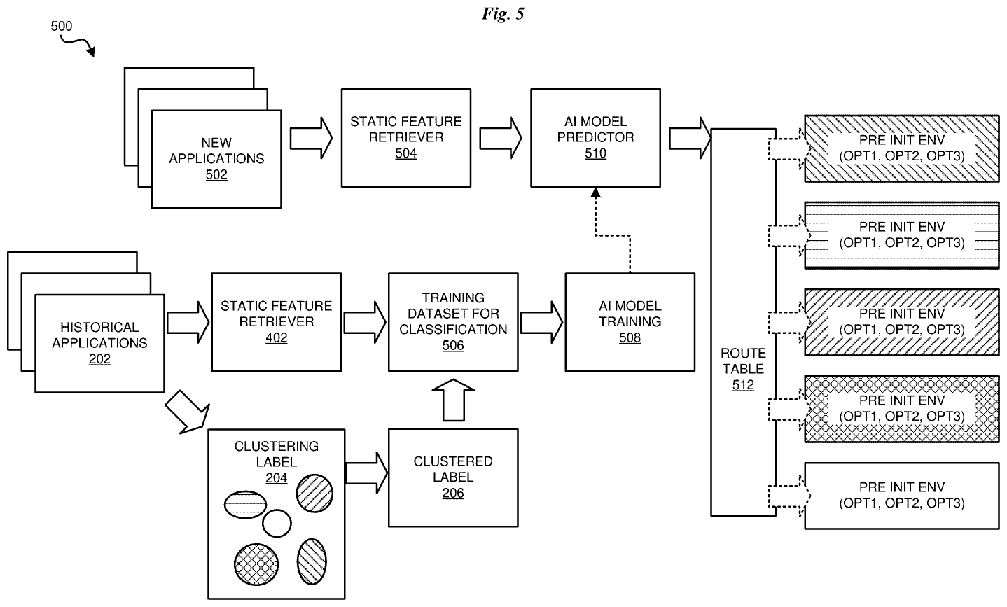

With reference to FIG. 5, this figure depicts a block diagram illustrating an embodiment predicting application requirements and routing the applications to the appropriate pre-initialization environment. The embodiment depicts the process of training a classification AI model to predict the application's performance requirement. Historical data 202 is gathered from the applications. Static features are retrieved from the historical data from the static feature retriever 402. This is done as depicted in FIG. 4. The embodiment also includes gathering the performance data from the applications 202 and clustering the data into nodes in the clustering labeling block 204. The performance index could be tuned, by non-limiting example to include large page size, heap size, stack size, head pool, and resource contention of the application. The training data set for classification 506 is then gathered using the static features and clustered labels 206 and the training data set is fed into the AI model training block 508. After training, the Al model predictor 510 will be used to predict the most suitable pre-initialization environments during fun time.

New applications 502 will be fed into the system and the static features retriever 504 will gather static features of the new applications. The static features will be fed into the AI model predictor 510. The AI model predictor 510 will, using the AI model training 508, sort the new applications into the route table 512 and then into the appropriate pre-initialization environment based on the clustering nodes from the clustering label box.

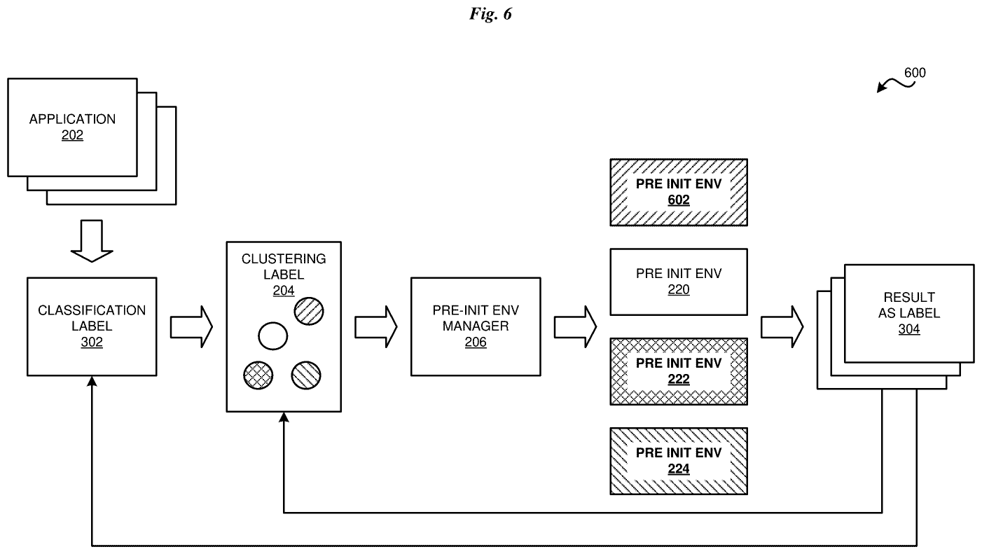

With reference to FIG. 6, this figure depicts an example of the embodiment dynamically adjusting. This is an example of scalability of the pre-initialization environment. In this example, the initialization has been preformed and the AI model has been trained. The method includes taking the resulting features of the applications routed to 304 the pre-initialization environments in real time and using those resulting as labels to feed into the clustering label block 204. The embodiment will recalibrate, using the clustering algorithm, the performance index nodes based on the new resulting labels. After recalibrating the clustering label, the embodiment will retrain the AI classification model using the new clustering training data. If the clustering label creates new clusters after labeling, the pre-initialization manager 206 will tell the pre-initialization manager to create a new pre-initialization environment 602. New performance index labels will also be added to the pre-initialization environment. The new labels will be added to the AI classification model in order to route new applications that are suitable for the new pre-initialization environment to the new pre-initialization environment.

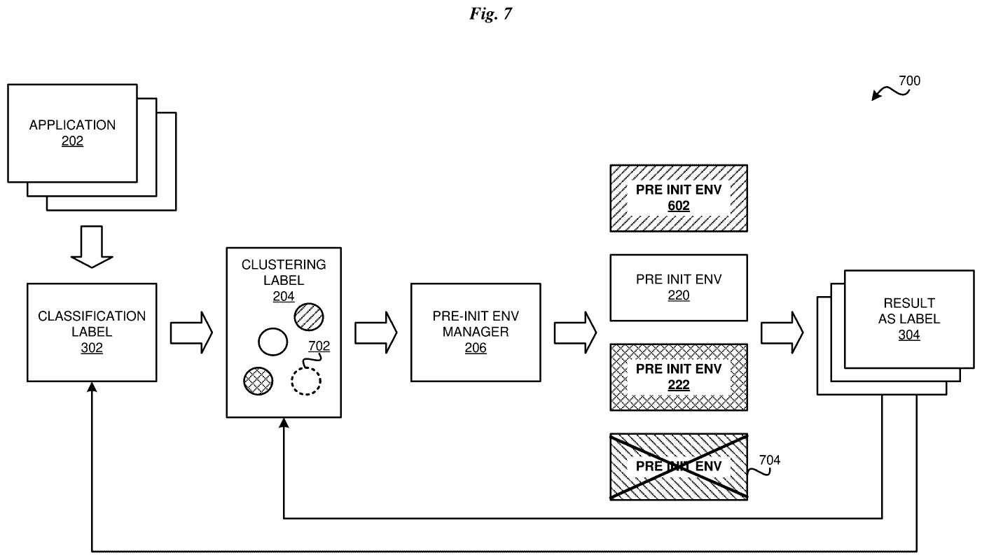

With reference to FIG. 7, this figure depicts an example of the embodiment dynamically adjusting to remove a pre-initialization environment. As depicted, the method includes taking the resulting features of the applications routed to 304 the pre-initialization environments in real time and using those resulting as labels 304 to feed into the clustering label block 204. In this example, after recalibrating one node 702 in the clustering label block 204 is no longer active. The node may continue to be requested by an application, but the node is no longer available. The clustering label block 204 will tell the pre-initialization environment manager 206 to remove the pre-initialization environment 704 corresponding to the node 702. Removing the pre-initialization environment saves resources including space, memory, and time of the system. After removal of the pre-initialization environment the AI classification will be retrained to prevent new applications from being routed to the removed pre-initialization environment 704.

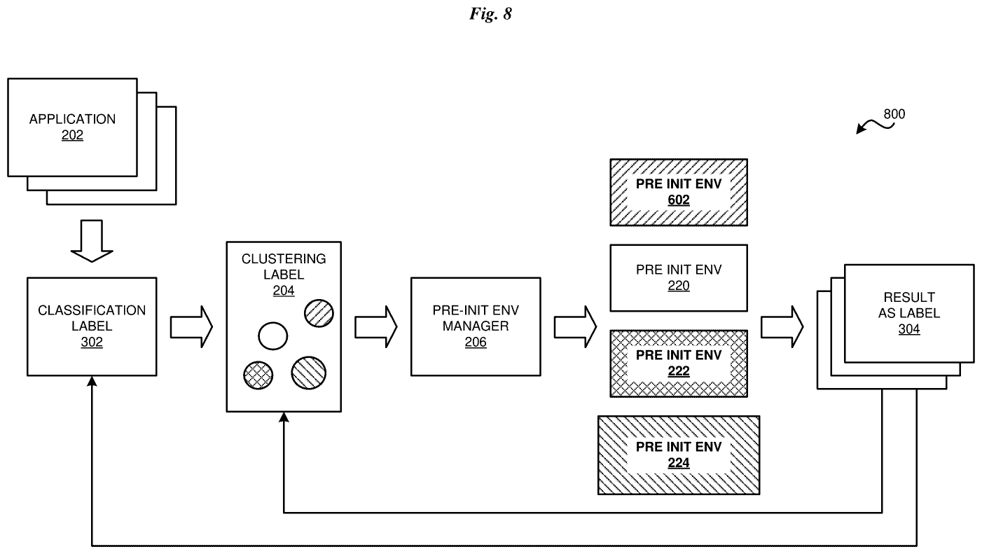

With reference to FIG. 8, this figure depicts an example of the embodiment dynamically adjusting to resize a pre-initialization environment. As depicted, the method includes taking the resulting features of the applications routed to 304 the pre-initialization environments in real time and using those resulting as labels 304 to feed into the clustering label block 204. In this example, one of performance indexes increased significantly compared to existing pre-initialization environment. In this situation, the clustering label performance index tells the manager to increase pre-initialization environment corresponding to the increased node of the performance index clustering label. The pre-initialization environment 224 was rescaled. The rescaling triggered the AI classification model to retain based on the latest date in order for new applications to be routed to new the re-scaled pre-initialization environment. This may improve efficiency of the data system because more like applications are in the pre-initialization environment together.

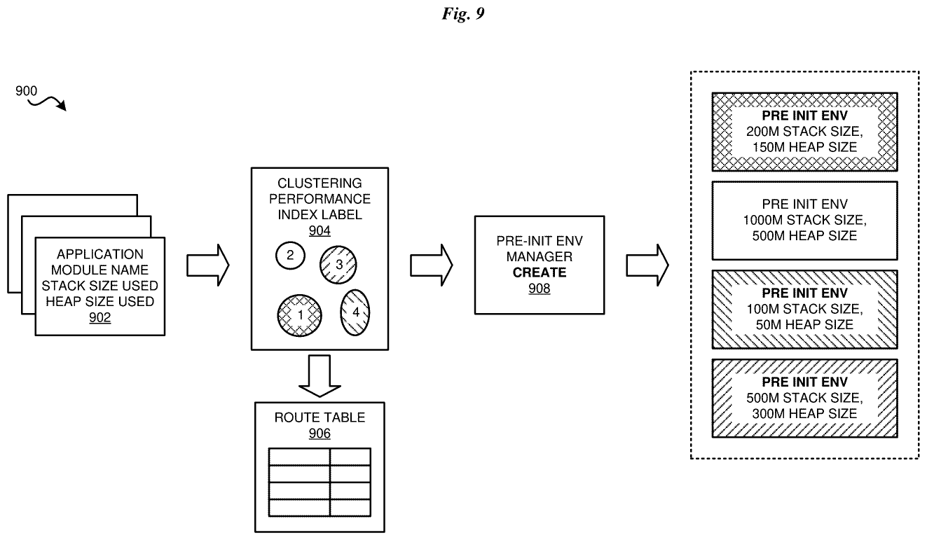

With reference to FIG. 9, this figure depicts an example of initializing storage tuning of pre-initialization environments in accordance with an illustrative embodiment. The performance indexes and corresponding nodes can be tuned to focus on specific features of an application. Tuning as referred to herein means adjusting the performance index nodes and corresponding pre-initialization environments based on particular sizes. In this example, the performance index metric of interest includes module name, stack size used, and heap size used. The tuning includes collecting historical data 902 and clustering the data by performance index metrics 904. The clustering label 904 is then used as a runtime option to create an initial pre-initialization environment. The pre-initialization environment manager 908 provisions a new pre-initialization environment corresponding to the clustering nodes. The pre-initialization environment stack size and heap size will be based on the clustering label. The method includes updating the route table with the stack size and heap size parameters.

In this example, a first application is named “appl” and has a stack size of 200 M and a heap size of 300 M. A second application is named “appo” and has a stack size of 100 M and a heap size of 100 M. A third application is named “app1” and has a stack size of 500 M and a heap size of 1000 M. A fourth application is named “app2” and has a stack size of 50 M and a heap size of 200 M. The corresponding clusters are cluster 1 centroid: 200, 150; cluster 2 centroid: 100, 50; Cluster 3 Centroid: 500, 300, and cluster 4 Centroid 1000, 500. As previously described, the stack size and heap size of the pre-initialization environment are the same as the corresponding clusters.

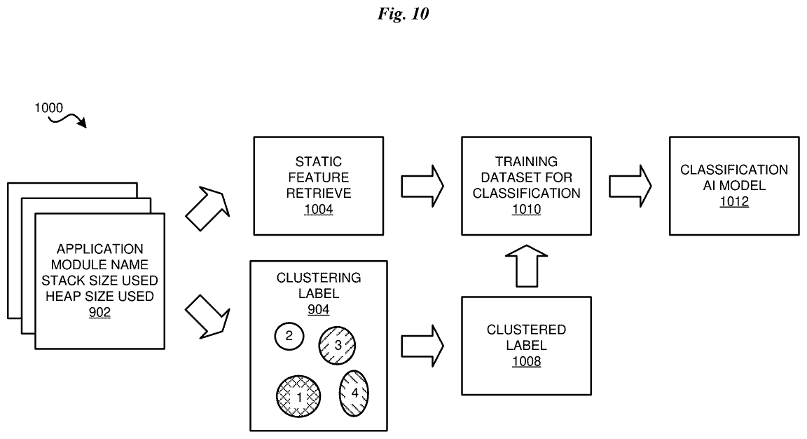

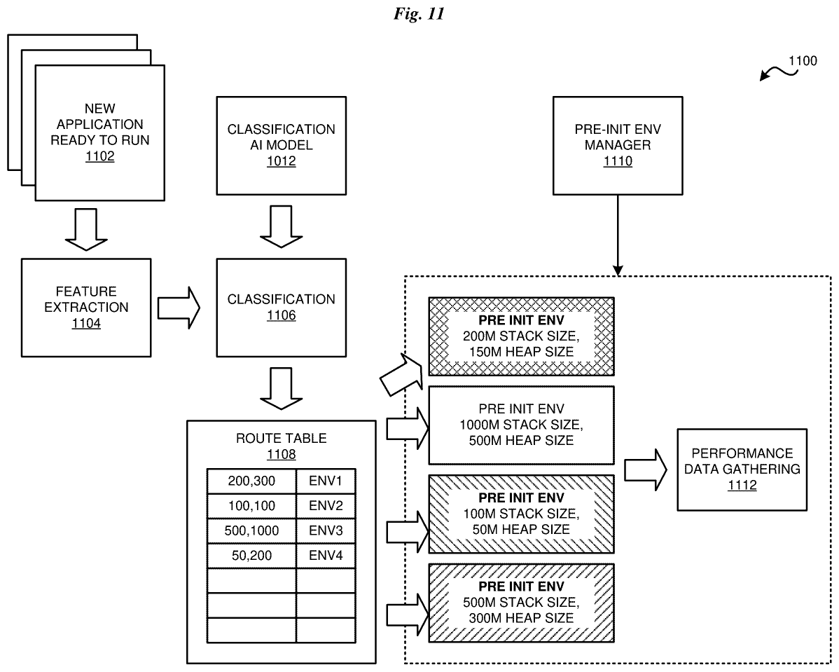

With reference to FIG. 10, this figure depicts training a classification AI model to predict and route applications into pre-initialization environments after initializing the pre-initialization environments to a storage tuning parameter. After the initialization as illustrated in FIG. 9, a classification model is trained to re-route applications to the appropriate pre-initialization environments. The method includes gathering static features in the static feature retriever box 1004 from the group of applications 902 and modules. The method then includes retrieving labels from the clustering performance index label 904 using a clustering algorithm. The method then includes feeding the clustering labels into the training dataset 1010 for classification. The classification AI model 1012 then reads to predict and route applications to the appropriate pre-initialization environment as will be illustrated in FIG. 11.

With reference to FIG. 11, this figure depicts the process of predicting and routing applications into pre-initialized environments based on performance index metrics in accordance with an illustrated embodiment. The method involves gathering static features on the new applications. The application features are extracted in the feature extraction block 1104. The performance index is predicted using the classification AI model 1012 trained previously in FIG. 10. The classification AI model will predict the most suitable performance index and feed it into the route table. Once in the routing table, the pre-initialization environment manager will check the route table and route the application to the appropriate pre-initialization environment. The system will gather real time performance to dynamically adjust the pre-initialization environments.

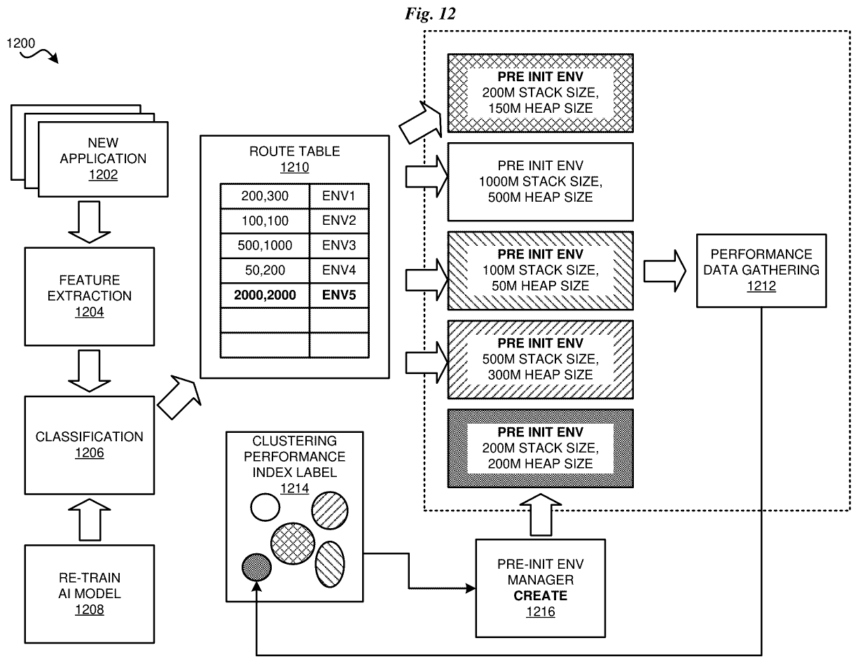

With reference to FIG. 12, this figure depicts dynamically adjusting pre-initialization environments in accordance with an illustrated embodiment. The method includes periodically recalibrating, using a clustering algorithm, the performance index nodes 1214 using performance data gathered 1212 from the pre-initialization environments. This periodic recalibrating allows new cluster nodes to be created adaptively as needed by the system. This may, by non-limiting example, reduce costs and downtime that may be associated with needing to manually add and remove pre-initialization environments in a data center system. If a new cluster node is to be added the system calls pre-initialization manager 1216 to create a new pre-initialization environment. The route table 1210 is updated with the new node 2000, 2000 ENV 5. The system then re-trains the classification AI model 1208 using the new clustering node label in order for new applications to be routed to the pre-initialization environment.

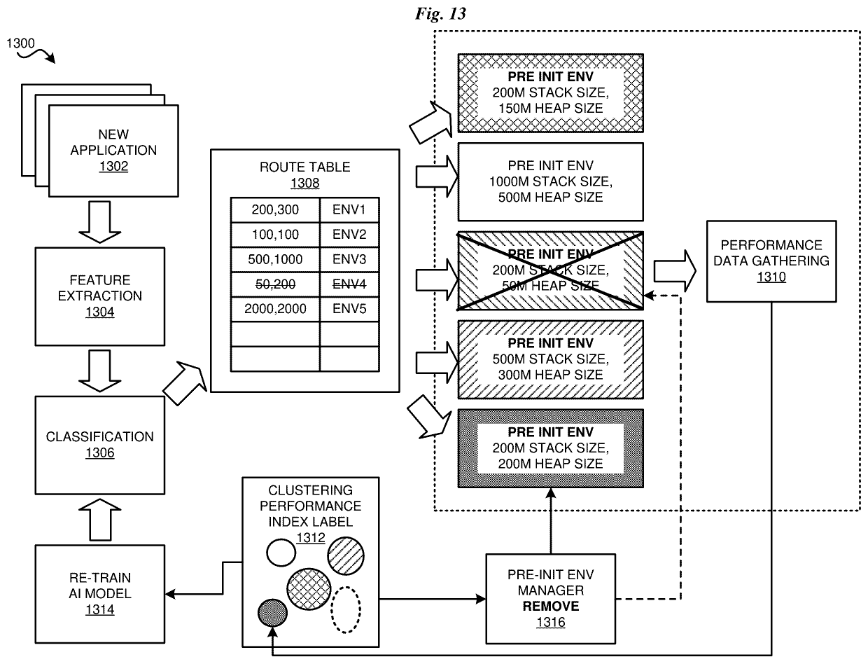

With reference to FIG. 13, this figure depicts dynamically adjusting pre-initialization environments to remove a pre-initialization environment in accordance with an illustrated embodiment. The method includes periodically recalibrating, using a clustering algorithm, the performance index nodes 1312 using performance data gathered 1310 from the pre-initialization environments. In this particular embodiment, a cluster node was no longer active after the periodic recalibrating, using a clustering algorithm, of the performance index metrics. When a cluster node is no longer active or does not exist in the system then the pre-initialization manager is called to remove the pre-initialization environment (200 M stack size, 50 M heap size). The classification AI model will then be retrained using the remaining clustering labels to re-route applications into the remaining pre-initialization environments.

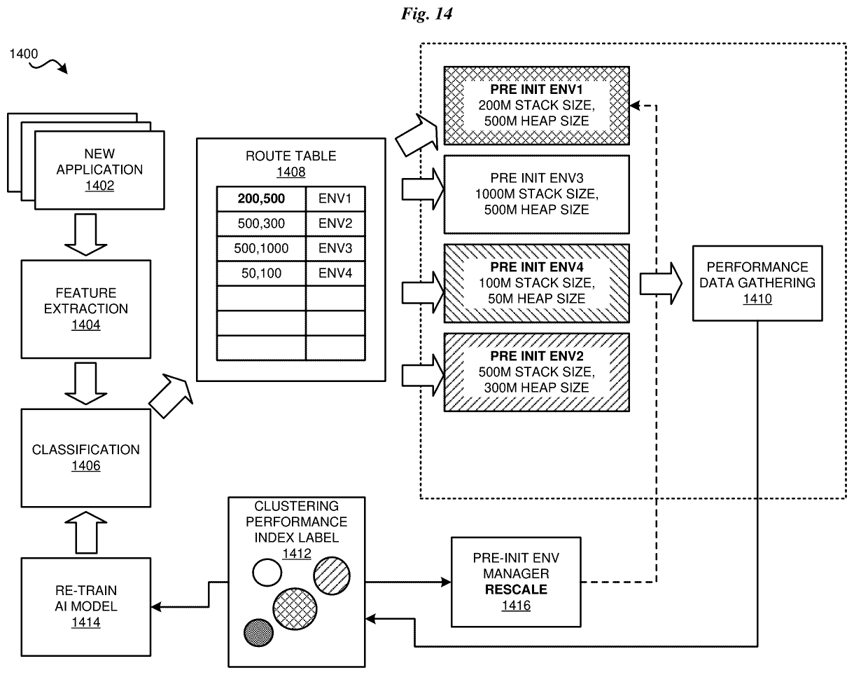

With reference to FIG. 14, this figure depicts this figure depicts dynamically adjusting pre-initialization environments to resize a pre-initialization environment in accordance with an illustrated embodiment. The method includes periodically recalibrating, using a clustering algorithm, the performance index nodes 1412 using performance data gathered 1410 from the pre-initialization environments. After recalibrating, a cluster node may be rescaled. As referred to herein rescaled may include increasing the size of node or decreasing the size of the node. If a cluster node is to be rescaled based on real time performance data, the pre-initialization environment is called to reset the pre-initialization environment runtime option, As illustrated, PRE INIT ENV1 changed from a size of 200 M stack size, 300 M heap size to 200 M stack size and 300 M heap size in response to a corresponding rescaling of a cluster node. The system will update the route table to correspond with the change in the pre-initialization environment. The classification AI model will then be retrained using the remaining clustering labels to re-route applications into the remaining pre-initialization environments.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
accepting a request from a group of applications to generate a performance-based index table for a workload based at least in part on a feature of the applications;
generating the performance-based index table for the workload, wherein the performance-based index is based on a memory efficiency;
building a label feature by analyzing a static program feature of the application in the group of applications and the performance-based index table;
constructing, using clustering algorithms, a model for provisioning a pre-initialization environment using a label feature;
loading, using the label feature, the applications in the group of applications into the pre-initialization environment;
introducing a selection policy for a switch in a pre-initialization environment in an application to balance usage of at least one resource; and
updating input to the model in response to monitoring a traffic of requests and collecting runtime data of the workload, wherein updating the model comprises adjusting the model for provisioning the pre-initialization environment.

2. The computer-implemented method of claim 1, wherein the resource of the pre-initialization environment comprises space, memory, and speed.

3. The computer-implemented method of claim 1, further comprising providing a manager to support scaling of the pre-initialization environment based on collection of runtime data of the workload.

4. The computer-implemented method of claim 3, wherein scaling comprises at least one of inserting, updating, and deleting the pre-initialization environment.

5. The computer-implemented method of claim 1, wherein adjusting the model for provisioning the pre-initialization environment comprises increasing a size of the pre-initialization environment.

6. The computer-implemented method of claim 1, wherein adjusting the model for provisioning the pre-initialization environment comprises decreasing a size of the pre-initialization environment.

7. The computer-implemented method of claim 1, wherein adjusting the model for provisioning the pre-initialization environment comprises deleting the pre-initialization environment.

8. The computer-implemented method of claim 1, wherein adjusting the model for provisioning the pre-initialization environment comprises creating the pre-initialization environment.

9. The computer-implemented method of claim 1, wherein a static program features of the application comprises sorting applications using an intensity of input/output operations of the application, a memory efficiency of the application and an actual response time of the application.

10. The computer-implemented method of claim 1, further comprising predicting using an artificial intelligence algorithm, a usage of the pre-initialization environments by applying a program feature and a resource across the program features.

11. A computer program product comprising one or more computer readable storage media, and program instructions collectively stored on the one or more computer readable storage media, the program instructions executable by a processor to cause the processor to perform operations comprising:
accepting a request from a group of applications to generate a performance-based index table for a workload based on a feature of the applications;
generating the performance-based index table for the workload, where the performance-based index is based on a memory efficiency;
building a label feature by analyzing a static program feature of the applications in the group of applications and the performance-based index table;
constructing, using clustering algorithms, a model for provisioning a pre-initialization environment using a label feature;
loading, using the label feature, the applications in the group of applications into the pre-initialization environment;
introducing a selection policy for a switch in a pre-initialization environment in an application to balance usage of at least one resource; and
updating input to the model in response to monitoring a traffic of requests and collecting runtime data of the workload, wherein updating the model comprises adjusting the model for provisioning the at least one pre-initialization environment.

12. The computer program product of claim 11, wherein the stored program instructions are stored in a computer readable storage device in a data processing system, and wherein the stored program instructions are transferred over a network from a remote data processing system.

13. The computer program product of claim 11, wherein the resource of the pre-initialization environment comprises space, memory, and speed.

14. The computer program product of claim 11, further comprising providing a manager to support scaling of the pre-initialization environment based on collection of runtime data of the workload.

15. The computer program product of claim 11, wherein scaling comprises inserting, updating, and deleting the pre-initialization environment.

16. The computer program product of claim 11, further comprising predicting using an artificial intelligence algorithm, a usage of the pre-initialization environments by applying one program feature and one resource across the program features.

17. A computer system comprising a processor and one or more computer readable storage media, and program instructions collectively stored on the one or more computer readable storage media, the program instructions executable by the processor to cause the processor to perform operations comprising:
accepting a request from a group of applications to generate a performance-based index table for a workload based on a feature of the applications;
generating the performance-based index table for the workload;
building a label feature by analyzing a static program feature of the applications in the group of applications and the performance-based index table;
constructing, using clustering algorithms, a model for provisioning a pre-initialization-environment using the label feature;
loading, using the label feature, the applications in the group of applications into the pre-initialization environment;
introducing a selection policy for a switch in the pre-initialization environment in an applications to balance usage of at least one resource; and
updating input to the model in response to monitoring a traffic of requests and collecting runtime data of the workload, wherein updating the model comprises adjusting the model for provisioning the pre-initialization environments.

18. The computer system of claim 17, wherein scaling comprises inserting, updating, and deleting the at least one pre-initialization environment.

19. The computer system of claim 17, further comprising predicting, using an artificial intelligence algorithm, a usage of the pre-initialization environment by applying a program feature and a resource across the program features.

20. The computer system of claim 17, further comprising providing a manager to support scaling of the pre-initialization environment based on collection of runtime data of the workload.

21. A computing environment comprising:
a shared pool of configurable computing resources;
at least one data processing system included in the configurable computing resources, the at least one data processing system comprising a processor unit and a data storage unit;
a service delivery model to deliver on-demand access to the shared pool of resources;
a metering capability to measure a service delivered via the service delivery model; and
program instructions collectively stored on one or more computer readable storage media, the program instructions executable by the processor unit to cause the processor unit to perform operations comprising:
accepting a request from a group of applications to generate a performance-based index table for a workload based at least in part on a feature of the applications;
generating the performance-based index table for the workload, wherein the performance-based index is based on a memory efficiency;
building a label feature by analyzing a static program feature of the application in the group of applications and the performance-based index table;
constructing, using clustering algorithms, a model for provisioning a pre-initialization environment using a label feature;
loading, using the label feature, the applications in the group of applications into the pre-initialization environment;
introducing a selection policy for a switch in a pre-initialization environment in an application to balance usage of at least one resource; and
updating input to the model in response to monitoring a traffic of requests and collecting runtime data of the workload, wherein updating the model comprises adjusting the model for provisioning the pre-initialization environment.

22. The computer environment of claim 21, wherein scaling comprises inserting, updating, and deleting the at least one pre-initialization environment.

23. The computer environment of claim 21, further comprising predicting, using an artificial intelligence algorithm, a usage of the pre-initialization environment by applying a program feature and a resource across the program features.

24. A software service delivery architecture comprising:
a shared pool of configurable computing resources;
at least one data processing system included in the shared pool of configurable computing resources, the at least one data processing system comprising a processor unit and a data storage unit;
at least one data networking component configured to enable data communication with the at least one data processing system;
an application control mechanism to execute a software application that is deployed to execute using the at least one data processing system; and
program instructions of the software application, wherein the program instructions are executable by the processor unit to cause the processor unit to perform operations comprising:
accepting a request from a group of applications to generate a performance-based index table for a workload based at least in part on a feature of the applications;
generating the performance-based index table for the workload, wherein the performance-based index is based on a memory efficiency;
building a label feature by analyzing a static program feature of the application in the group of applications and the performance-based index table;
constructing, using clustering algorithms, a model for provisioning a pre-initialization environment using a label feature;
loading, using the label feature, the applications in the group of applications into the pre-initialization environment;
introducing a selection policy for a switch in a pre-initialization environment in an application to balance usage of at least one resource; and
updating input to the model in response to monitoring a traffic of requests and collecting runtime data of the workload, wherein updating the model comprises adjusting the model for provisioning the pre-initialization environment.

25. The software service delivery architecture of claim 24, further comprising predicting, using an artificial intelligence algorithm, a usage of the pre-initialization environment by applying a program feature and a resource across the program features.
